(19) United States
(12) Patent Application Publication
(10) Pub. No.: US 2024/0323055 A1
(43) Pub. Date: Sep. 26, 2024

(54) METHODS AND SYSTEMS FOR NON-TRIGGER BASED SOUNDING

(71) Applicant: HUAWEI TECHNOLOGIES CO., LTD., SHENZHEN (CN)

(72) Inventors: Jung Hoon SUH, Kanata (CA); Osama ABOUL-MAGD, Kanata (CA); Yan XIN, Kanata (CA); Kwok Shum AU, Kanata (CA)

(73) Assignee: HUAWEI TECHNOLOGIES CO., LTD., SHENZHEN (CN)

(21) Appl. No.: 18/591,937

(22) Filed: Feb. 29, 2024

Related U.S. Application Data
(60) Provisional application No. 63/453,649, filed on Mar. 21, 2023.

(51) Int. Cl. H04L 25/02; H04B 7/06; H04W 24/10

(52) U.S. Cl. CPC H04L 25/0226; H04B 7/0626; H04W 24/10

(57) ABSTRACT

Systems and methods for non-trigger based sounding is provided. According to one aspect, a method is provided. The method includes, sending, by a first access point (AP) to a station (STA), a null data packet announcement (NDPA) frame. The NDPA frame may include a first indication indicating a multi-user (MU) channel state information (CSI) feedback (FB) type. The method may further include sending, by the first AP to the STA, a first null data packet (NDP). The method may further include receiving, by the first AP from the STA, a CSI report frame based on the MU CSI FB.

### CROSS-REFERENCE TO RELATED APPLICATIONS

This application claims the benefit of and priority to U.S. Provisional Patent Application No. 63/453,649 filed on Mar. 21, 2023, entitled “Methods and Systems for Non-TB Sounding”, the contents of which are incorporated herein by reference in their entirety.

### FIELD OF THE INVENTION

The present invention pertains to the field of communication networks, and in particular to methods and systems for non-trigger based (TB) sounding.

### BACKGROUND

Channel state information (CSI) measurements were introduced in IEEE 802.11n and IEEE 802.11ac in the context of multiple-input and multiple-output (MIMO). CSI may reflect the wireless signal propagation characteristics for a link between a transmitter and a receiver at certain carrier frequencies. CSI may be estimated by a receiver and fed back to the transmitter via a sounding procedure. However, existing non-trigger based (TB) sounding procedures may result in poor error rate and system performance, particularly, in high-speed and dynamic channel conditions. These limitations may further result in inadequate CSI feedback or poor channel reconstruction at the beamformer side, which can lead to suboptimal transmission parameters and degraded system performance.

Therefore, there is a need for methods and systems for non-TB sounding that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides for methods and systems for non-TB sounding. According to one aspect, a method of non-TB sounding is provided. The method includes, sending, by a first access point (AP) to a station (STA), a null data packet announcement (NDPA) frame. The NDPA frame includes a first indication indicating a multi-user (MU) channel state information (CSI) feedback (FB) type. The method further includes sending, by the first AP to the STA, a first null data packet (NDP). The method further includes receiving, by the first AP from the STA, a CSI report frame based on the MU CSI FB.

In some embodiments, the first indication may be indicated via one or more subfields in a STA info field of the NDPA frame. The one or more subfields may include a Feedback Type And Ng subfield and a Codebook Size subfield. ‘Ng’ may refer to the number of subcarrier grouping. The first indication may be indicated via a bit combination of the one or more subfields.

In some embodiments, the bit combination may be based on setting bit 25 (B25) and bit 26 (B26) of the Feedback Type And Ng subfield respectively to: 0, 1. The bit combination may be based on setting B25 and the B26 of the Feedback Type And Ng subfield and bit 28 (B28) of the Codebook Size subfield respectively to: 0, 1, 1. The bit combination may be based on setting the B25, the B26 and the B28 respectively to: 0, 0, 1. The bit combination may be based on setting the B25, the B26 and the B28 respectively to: 1, 0, 0. The bit combination may be based on setting the B25, the B26 and the B28 respectively to: 1, 0, 1.

In some embodiments, the first NDP may be sent a short interframe space (SIFS) time unit after sending the NDPA frame. The NDPA frame may include a second indication indicating a joint sounding among the first AP and the second AP. The second indication may further indicate that a second NDP from the second AP is to be transmitted to the STA concurrently with the first NDP. The second indication is indicated via at least one bit in the NDPA frame. The second indication is indicated in a common info field of the NDPA frame.

According to another aspect, another method is provided. The method includes receiving, by a station (STA) from a first access point (AP), a null data packet announcement (NDPA) frame. The NDPA frame includes a first indication indicating a multi-user (MU) channel state information (CSI) feedback (FB) type. The method further includes receiving, by the STA from the first AP, a first null data packet (NDP). The method further includes sending, by the STA to the first AP, a CSI report frame based on the MU CSI FB.

In some embodiments, the first indication may be indicated via one or more subfields in a STA info field of the NDPA frame. The one or more subfields may include a Feedback Type And Ng subfield and a Codebook Size subfield. The first indication may be indicated via a bit combination of the one or more subfields. The bit combination may be based on setting bit 25 (B25) and bit26 (B26) of the Feedback Type And Ng subfield respectively to: 0, 1. The bit combination may be based on setting B25 and the B26 of the Feedback Type And Ng subfield and B28 of the Codebook Size subfield respectively to: 0, 1, 1. The bit combination may be based on setting the B25, the B26 and the B28 respectively to: 0, 0, 1. The bit combination may be based on setting the B25, the B26 and the B28 respectively to: 1, 0, 0. The bit combination may be based on setting the B25, the B26 and the B28 respectively to: 1, 0, 1. The first NDP is received a short interframe space (SIFS) time unit after receiving the NDPA frame.

In some embodiments, the NDPA frame may include a second indication indicating a joint sounding among the first AP and a second AP. The second indication may further indicate that a second NDP from the second AP is to be transmitted to the STA concurrently with the first NDP. The second indication may be indicated via at least one bit in the NDPA frame. The second indication is indicated in common info field of the NDPA frame.

In some embodiments, the method may further include receiving, by the STA from the second AP, the second NDP concurrently with the first NDP. The method may further include sending, by the STA from to the second AP, the CSI report frame.

According to another aspect, an apparatus is provided. The apparatus includes modules configured to perform one or more of the methods described herein.

According to one aspect, an apparatus is provided, where the apparatus includes: a processor and a memory. The memory storing machine executable instructions, which when executed by the processor, cause the apparatus to be configured to perform one or more of the methods described herein.

According to another aspect, a computer readable medium is provided, where the computer readable medium stores program code for execution by a device. The program code, upon execution causes the device to perform one or more of the methods described herein.

According to one aspect, a chip is provided, where the chip includes a processor and a data interface, and the processor reads, by using the data interface, instructions stored in a memory. The instructions, upon execution by the processor, cause the chip to be configured to perform one or more of the methods described herein.

Other aspects of the disclosure provide for apparatus, and systems configured to implement the methods disclosed herein. For example, wireless stations and access points can be configured with machine readable memory containing instructions, which when executed by the processors of these devices, configures the device to perform the methods disclosed herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates CSI FB types for non-TB sounding.

FIG. 2 illustrates an enhanced NDPA frame format, according to an aspect.

FIG. 3 illustrates a bit setting for MU CSI FB type, according to an aspect.

FIG. 4 illustrates a sounding procedure, according to an aspect.

FIG. 5 illustrates another enhanced NDPA frame format, according to an aspect.

FIG. 6 illustrates a sounding procedure involving multiple APs, according to an aspect.

FIG. 7 illustrates a non-TB sounding procedure, by an AP, according to an aspect.

FIG. 8 illustrates a non-TB sounding procedure, by a STA, according to an aspect.

FIG. 9 is an apparatus that may perform any or all of operations of the methods and features explicitly or implicitly described herein, according to one or more aspects of the present disclosure.

It will be noted that throughout the appended drawings, like features are identified by like reference numerals.

### DETAILED DESCRIPTION

Channel State Information (CSI) capabilities were first introduced in the IEEE 802.11n standard in the context of multiple-input and multiple-output (MIMO) transmissions. The CSI training sequence, as may be appreciated by a person skilled in the art, may be designed to measure the channel characteristics between a transmitter (e.g., an access point (AP)) and a receiver (e.g., a station (STA)). CSI may represent how an electric signal propagates from a transmitter to a receiver and the combined effect of scattering, fading, and power decay with distance of the signal.

CSI may reflect the wireless signal propagation characteristics for a link from a transmitter to a receiver at certain carrier frequencies. CSI measurements may include information when wireless signals transmit through surrounding objects and humans in time, frequency, and spatial domains. CSI measurements may be used for various wireless sensing applications. CSI measurements may include amplitude variation in CSI in the time domain, phase shifts in CSI in the spatial and frequency domains (e.g., transmit or receive antennas and carrier frequencies), phase shifts in CSI in the time domain.

An aspect of the disclosure provides for sounding procedure 700, by an AP. The procedure includes, sending, by a first access point (AP) to a station (STA), a null data packet announcement (NDPA) frame. The NDPA frame may include a first indication indicating a multi-user (MU) channel state information (CSI) feedback (FB) type. The procedure further includes sending, by the first AP to the STA, a first null data packet (NDP). The procedure further includes receiving, by the first AP from the STA, a CSI report frame based on the MU CSI FB.

Another aspect of the disclosure provides for a sounding procedure 800, by a STA. The procedure includes receiving, by a station (STA) from a first access point (AP), a null data packet announcement (NDPA) frame. The NDPA frame may include a first indication indicating a multi-user (MU) channel state information (CSI) feedback (FB) type. The procedure further includes receiving, by the STA from the first AP, a first null data packet (NDP). The procedure further includes sending, by the STA to the first AP, a CSI report frame based on the MU CSI FB.

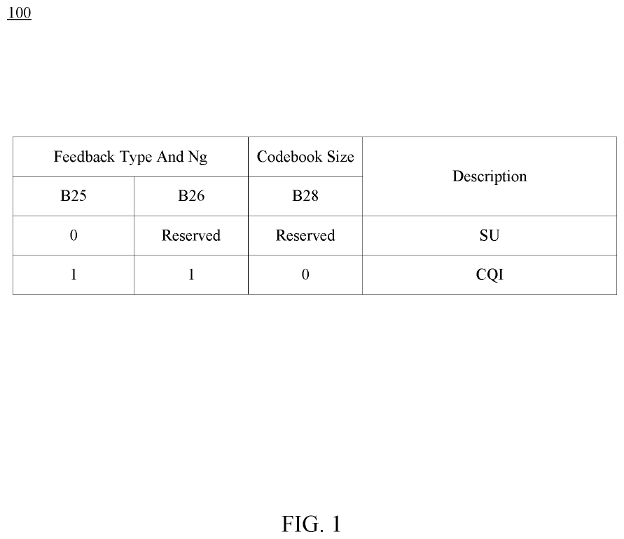

The CSI FB types for non-TB sounding in High Efficiency (HE) IEEE 802.11ax and Extremely High Throughput (EHT) IEEE 802.11be are only for Single User (SU) and Channel Quality Indicator (CQI) types as shown in FIG. 1. FIG. 1 illustrates CSI FB types for non-TB sounding.

The Table 100 of FIG. 1 shows the Feedback Type And Ng subfield and Codebook Size subfield encoding for HE and EHT non-TB sounding.

As may be appreciated, CQI feedback is computed by averaging the Eigen values of a channel over an indicated frequency range for Orthogonal Frequency Divisional Multiplexing Access (OFDMA) scheduling purposes, whereas the SU CSI FB type is the feedback of the right singular matrix of the channel along with the average Eigen values of the channel per receiver (RX) stream.

The beamforming steering matrix (Precoder matrix) computation can be done with a simple Eigen Beamforming (EGBF). The beamforming steering matrix computation can also be done in an advanced manner as well such as Zero Forcing-Beamforming (ZF-BF).

In a sounding procedure, a receiver (e.g. a station (STA)) may estimate a channel between the receiver and an associated access point (AP). The estimated channel may be denoted as H, where channel (H) may be given as H=UΣV^{H}. V is the right singular matrix, and Σ is the Eigen value of the channel H. A STA performs decomposition on H to derive the metrics for feedback. Usually, two metrics are fed back in a CSI feedback: Σ and V. U is not fed back usually because the AP side can reconstruct H based on ΣV, and thus reduce overhead. A CQI CSI FB type includes only the Σ (Eigen values of the channel H). An SU CSI feedback type includes V per subcarrier and average value of Σ per stream. Thus, the Right Singular Matrix, V, can be fed back to the beamformer in case of the SU CSI Feedback (FB) type. This right singular matrix V can be used for a beam steering matrix in the beamformer side which is the Eigen beamforming. The average Signal-to-Noise Ratio (SNR), averaged Eigen value per RX stream, can be used for a water-filling algorithm of transmitter (TX) power per stream.

Usually, the H value is determined on a per subcarrier basis, and the feedback metrics are per subcarrier. Since subcarriers are correlated, not all subcarriers need to be fed back. For example, feedback may be based on every two, four, eight or other appropriate number of subcarriers, depending on the channel correlation. For SU CSI feedback type, V is fed back per every subcarrier, but Σ is not fed back per every subcarrier (which does not have to, and thus Σ is fed back per stream).

In the current IEEE 802.11 standard, all the Modulation and Coding System (MCS) are the same across the stream (every stream applies the transmitter with the same MCS). As may be appreciated, the Eigen value Σ is largest in the dominant stream. The first stream is usually the largest. The second stream is usually the second largest, and so on. Thus, the Eigen value, Σ, diminishes with increasing number of streams. According to an aspect, different Modulation and Coding System (MCS) should better be applied to each TX stream with the average SNR information.

However, for advanced beamforming steering matrix computations, such as for a ZF-BF Precoder matrix computation, it requires a multi-user (MU) CSI FB type where the Eigen value of the channel per subcarrier (actually per Ng-subcarriers) and per RX stream are fed back to the beamformer along with the right singular matrix, V. Since Σ (Eigen values) and V are fed back from the beamformee to the beamformer, the DL channel at the beamformer side may be constructed as follows: \tilde{H}=ΣV^{H}. Then, \tilde{H}^{H}(\tilde{H}\tilde{H}^{H}+σ²I) is the ZF-BF based BF Steering matrix.

Thus, the reconstructed channel, at the AP side, may represented by \tilde{H}. \tilde{H} may play the role of, and can be assumed to be H. σ² may refer to the variance of the noise, and/may refer to the identity matrix.

In comparing the performance of EGBF based SU-Multiple Input Multiple Output (MIMO) and the ZF-BF based SU-MIMO, the ZF-BF based SU-MIMO outperforms the EGBF based SU-MIMO. As may be appreciated, in ZF-BF, both metrics EV, i.e., an MU CSI FB type, may be needed, even for the non-TB sounding procedure. According to an aspect, an MU CSI FB type may be provided in a non-TB sounding case. In an aspect, the MU SCI FB type may be included as a FB type indication in a Null Data Packet Announcement (NDPA) frame.

The steering matrix computation for the SU-MIMO can be limited with the SU CSI FB type. According to an aspect, an MU CSI FB type may be provided for the non-TB sounding, which refers to a single STA for CSI FB. An MU CSI FB type may allow for an advanced beamforming steering matrix which may enhance the performance of SU-MIMO communications.

As may be appreciated, in a sounding procedure, an AP collects FB from one or more STAs during a period. When only one STA sends CSI FB, the sounding procedure may be referred to as a non-TB sounding (where no trigger frame is transmitted by the AP).

The CSI FB types for non-TB sounding in HE and EHT are limited to SU and CQI FB types. The CSI FB type is indicated in the Feedback Type And Ng subfield along with the Codebook Size subfield of an NDPA frame. According to an aspect, an MU CSI FB type for non-TB sounding case may be provided. In an embodiment, the MU CSI FB type may be indicated via a combination of bits in the Feedback Type And Ng subfield and the Codebook Size subfield of NDPA frame, as described herein.

In an aspect, an MU CSI FB type indication may be provided in an NDPA frame for non-TB sounding. In some aspects, the NDPA frame for HE or EHT may need to include an MU CSI FB type indication. The NDPA frames for future WLAN Standards amendments may need to include an MU CSI FB type indication.

In an embodiment, the MU CSI FB type may be indicated in an NDPA frame by setting bit 26 (B26) of the Feedback Type And Ng subfield in the STA Info field of NDPA frame to 1.

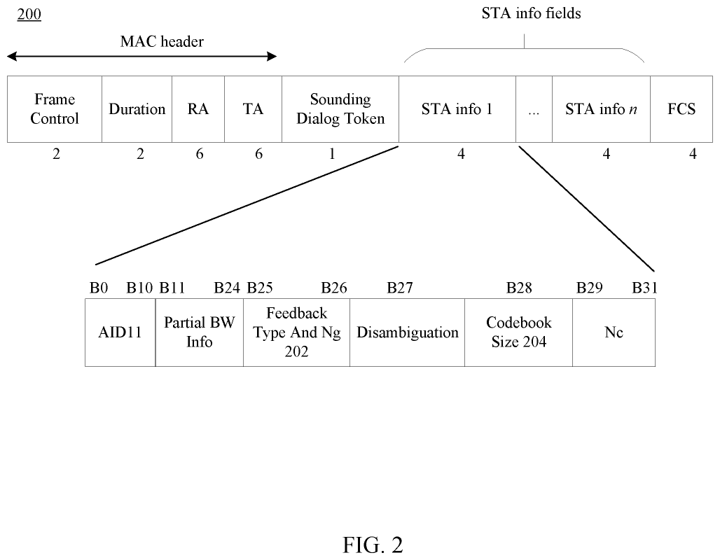

FIG. 2 illustrates an enhanced NDPA frame format, according to an aspect. The NDPA frame format 200 may be used for a non-TB sounding procedure. The NDPA frame format 200 may comprise a Media Access Control (MAC) header. The MAC header may include a plurality of fields indicating one or more of: frame control, duration (of frame transmission), receiver address (RA), and transmitter address (TA). The NDPA frame format 200 may further include a field for indicating a sounding dialog token. The NDPA frame format 200 may further include one or more STA info fields. The NDPA frame format 200 may further include a field for indicating a Frame Check Sequence (FCS).

Each STA info field may include a plurality of subfields indicating one or more of: Association ID (AID), Partial Bandwidth (BW) info, Feedback Type And Ng 202, disambiguation, Codebook Size 204, and number of space-time streams used by the transmitting station (Nc).

According to an aspect, the NDPA frame format 200 may indicate an MU CSI FB type in the STA info field. In an embodiment, the MU CSI FB type may be indicated via one or two subfields in a STA info field. In some embodiments, the MU CSI FB type may be indicated via a bit combination of the one or more subfields. In an embodiment, the one or more subfields may include the Feedback Type And Ng 202 and Codebook Size 204.

In some embodiments, the MU CIS FB type may be indicated in a combination of 3 bits in both the Feedback Type And Ng subfield (B25 and B26) and Codebook Size (B28)

Referring to Table 100 of FIG. 1, in HE and EHT variant NDPA frames, the SU CSI FB type is indicated with B25 set to 0 and with B26 and B28 being Reserved. However, in practice B26 and B28 are typically set to 0. For the case of a CQI FB type, this FB is indicated with setting B25 and B26 to 1 and setting B28 to 0.

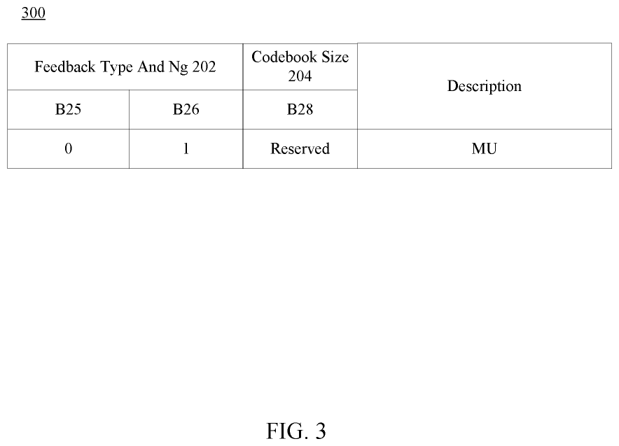

FIG. 3 illustrates a bit setting for MU CSI FB type, according to an aspect. Table 300 illustrates an MU CSI FB type setting for Feedback Type And Ng subfield. As illustrated, in an embodiment, for indicating an MU CSI FB type in a non-TB sounding NDPA frame, B25 and B26 of the Feedback Type And Ng subfield may be set, respectively, to 0 and 1, as illustrated. In Table 300, the MU CSI FB type is indicated via one subfield, the Feedback Type And Ng subfield. In other embodiments, the MU CSI FB type may be indicated via the combination of two subfields, Feedback Type And Ng 202 and Codebook Size 204.

According to an aspect, an MU CSI FB type indication in an NDPA frame may allow for an advanced Beamforming Steering Matrix (Precoding matrix) to be applied to the SU-MIMO data transmission using a non-TB sounding. An MU CIS FB type indication may allow for improved error-rate gain with the advanced Precoding, compared to the simple EGBF.

In some embodiments, the MU CSI FB type may be indicated by setting B26 in Feedback Type And Ng subfield to 1 along with setting B28 in the Codebook Size subfield to 1. In some embodiments, one or more other alternative combinations of the 3 bits; B25, B26, and B28 may be used to indicate the MU CSI FB type in the non-TB sounding NDPA frame.

In an embodiment, any combination of (B25, B26, and B28) which does not overlap with the indication of SU or CQI FB types, may be used to indicate the MU CSI FB type for non-TB sounding. For example, the MU CSI FB type may be indicated via setting the bits B25, B26 and B28 respectively to: (0, 1, 1), (0, 0, 1), (1, 0, 0), (1, 0, 1), etc.

As may be appreciated by a person skilled in the art, the enhanced NDPA fame format is not limited to HE and EHT applications, rather the enhanced NDPA frame may be applied to any non-TB sounding case.

The MU CSI FB type in a non-TB sounding NDPA may allow for improved bit error rate (BER) performance when using an advanced beamforming steering matrix computation (e.g., ZF-BF) compared to EGBF.

According to an aspect, an advanced Beamforming Steering Matrix (e.g. Precoding matrix) may be applied to SU-MIMO data transmission using the non-TB sounding based on MU CSI FB Type (included in the NDPA frame). MU CSI FB type in non-TB sounding case may allow for improved error-rate gain with the advanced Precoding compared to the simple EGBF

According to an aspect, an MU CSI FB Type may be indicated for non-TB sounding. An MU CSI FB type may allow for the indication of Eigen values per Ng subcarrier and per RX stream in the CSI FB report frame. The Ng subcarrier indicates the subcarrier grouping for which the corresponding Eigen value is to be fed back. The subcarrier grouping, Ng, may depend on the channel correlation. For example, in EHT, two values of Ng exist, 4 and 16. For Ng 4 case, channel is slightly more fluctuated (e.g., less correlated (small correlation bandwidth)) in the frequency domain compared to the Ng 16 case. When the correlation bandwidth is big, a bigger Ng size may be selected, e.g., Ng 16.

In some embodiments, an MU CSI FB type may be indicated by setting B26 as indicated in Table 9-45 of the EHT Specification, of the IEEE 802.11be standard. As described herein, the MU CSI FB type may be indicated via one or more alternatives ways for non-TB sounding.

According to an aspect, the downlink (DL) channel can be reconstructed in the beamformer side with the MU CSI FB type introduced in the non-TB sounding in order to compute an advanced Precoding matrix such as ZF-BF. As described herein, to reconstruct \tilde{H}, an MU CSI feedback type may be needed. As noted herein, the SU CSI FB does not feedback Eigen value, Σ, per Ng subcarrier, rather SU CSI FB feeds back an average Eigen value. Accordingly, via an MU CSI FB type for non-TB sounding, \tilde{H} may be reconstructed at the AP side. By being able to reconstruct \tilde{H} appropriate advanced beamforming may be done.

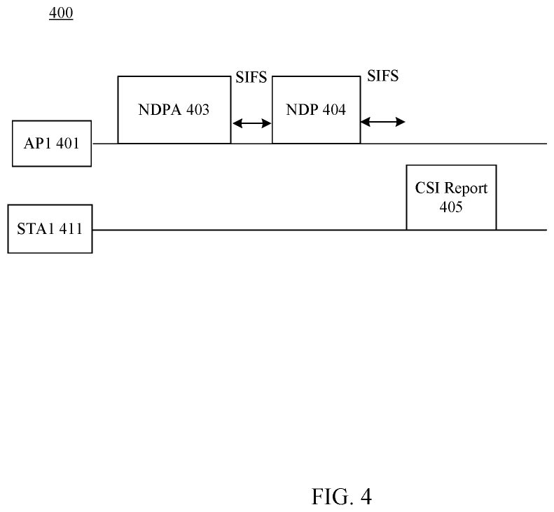

FIG. 4 illustrates a sounding procedure, according to an aspect. The procedure 400 may be a non-TB sounding procedure. 400 may include, sending, by AP1 401 to STA1 411, an NDPA frame 403 to announce the start of a sounding or beamforming procedure. The NDPA frame 403 may be similar to the NDPA frame 200. The NDPA frame format may include in its STA info field an MU CSI FB indication. The STA info field may be associated with STA1 411.

In some embodiments, a short interframe space (SIFS) time unit after sending the NDPA frame 403, sending, by the AP1 401 to STA1 411, a null data packet (NDP) 404 for STA1 to estimate the CSI. In some embodiments, SIFS time units after receiving the NDP 404, STA1 411 may send to AP1 401 a CSI report frame based on the MU CSI FB type indication of the NDPA 403. Accordingly, the CSI report frame 405 may be an MU CSI FB type.

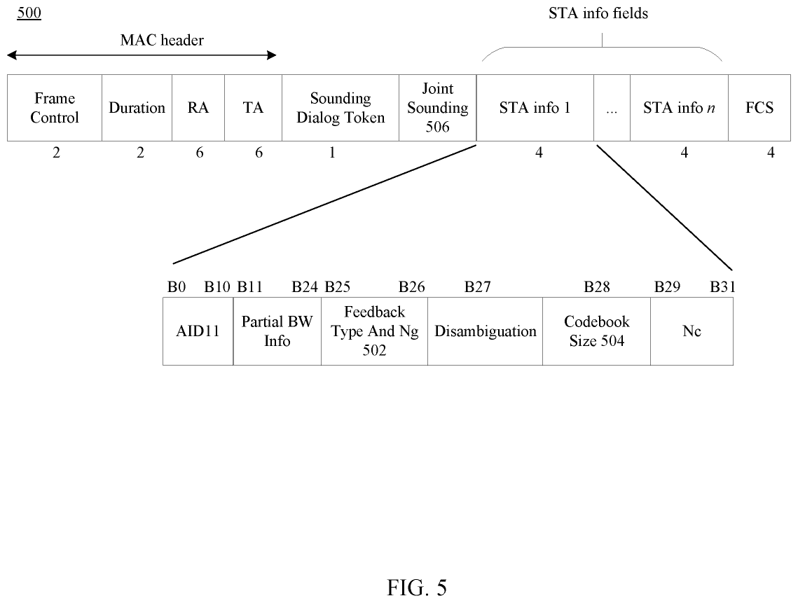

FIG. 5 illustrates another enhanced NDPA frame format, according to an aspect. The NDPA frame format 500 may be similar to the NDPA frame format 200. For example, NDPA frame format 500 may include an MU CSI FB type indication indicated via one or more subfields in the STA info field. The NDPA frame format 500 may indicate the MU CSI FB type via one or more of the Feedback Type And Ng subfield 502 and the Codebook Size 504 subfield. In an aspect, the NDPA frame format 500 may include a joint or concurrent sounding indication 506. The joint sounding indication 506 may indicate a joint sounding among multiple APs. The joint sounding indication 506 may indicate that each of the multiple APs may transmit an NDP to a STA concurrently or at the same time. In some embodiments, the joint sounding indication 506 may be indicated via at least one bit in the NDPA frame. In some embodiments, the joint sounding indication 506 may be indicated in a common info field of the NDPA frame. A Base Service Set (BSS) color (or any indication of BSS ID) of the collaborating AP or APs may follow the Joint Sounding indication in the common field of the NDPA.

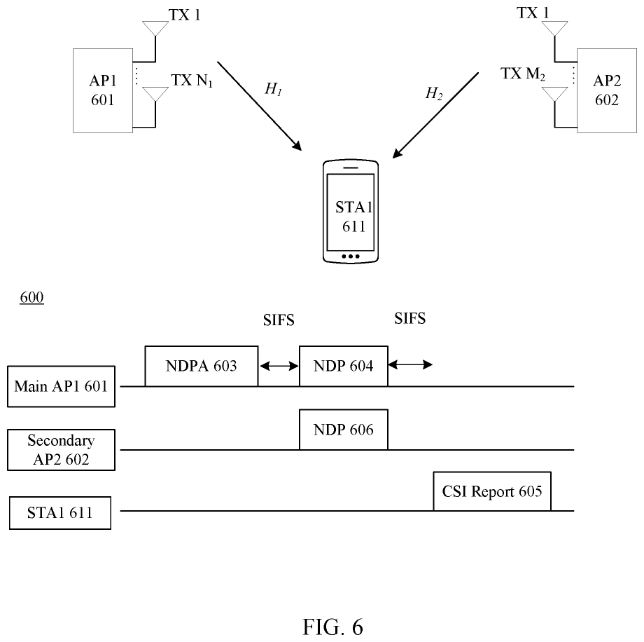

FIG. 6 illustrates a sounding procedure involving multiple APs, according to an aspect. Procedure 600 may be a non-TB sounding procedure. In FIG. 6, multiple APs, two APs in illustrated example, AP1 601 and AP2 602 may transmit to one STA1 611. In an embodiment, AP1 601 may be the main AP and AP2 602 may be a secondary AP in collaboration. In order to transmit to the same STA1 611, the precoding matrix may be computed, by the main AP1 601 and shared with AP2 602 via a connection between them. In some embodiments, AP1 601 and AP2 602 may be viewed as a distributed MIMO.

In the illustrated case of multiple APs transmitting to a single STA, an MU CSI feedback type may be needed. Referring to FIG. 6, procedure 600 may include, AP1 601 sending to STA1 611, an NDPA 603. The secondary AP2 602 may be in collaboration with the main AP1 601. NDPA 603 may have a frame format similar to the NDPA frame format 500. For example, NDPA 603 may include an MU CSI FB type indication. NDPA 603 may also include a joint sounding indication. The joint indication may indicate joint (concurrent) NDP transmission from participant APs (e.g. AP1 601 and AP2 602).

In an embodiment, procedure 600 may further include, a SIFS unit time after sending the NDPA 603, AP1 601 may send NDP 604 to STA1 611. At the same time as AP1, AP2 602 may send NDP 606 to STA1 611. STA1 611 may receive NDPs 604 and 606 from both AP1 601 and AP2 602 and compute the CSI. Procedure 600 may further include, STA1 611 sending CSI report frame 605 to each of the AP1 601 and AP2 602. According to the MU CSI FB type indication in the NDPA frame 603, the CSI report frame 605 may be an MU CSI FB type.

In an embodiment, the main AP1 601 may use the received CSI to compute the precoding matrix and share with AP2 602 via their connection.

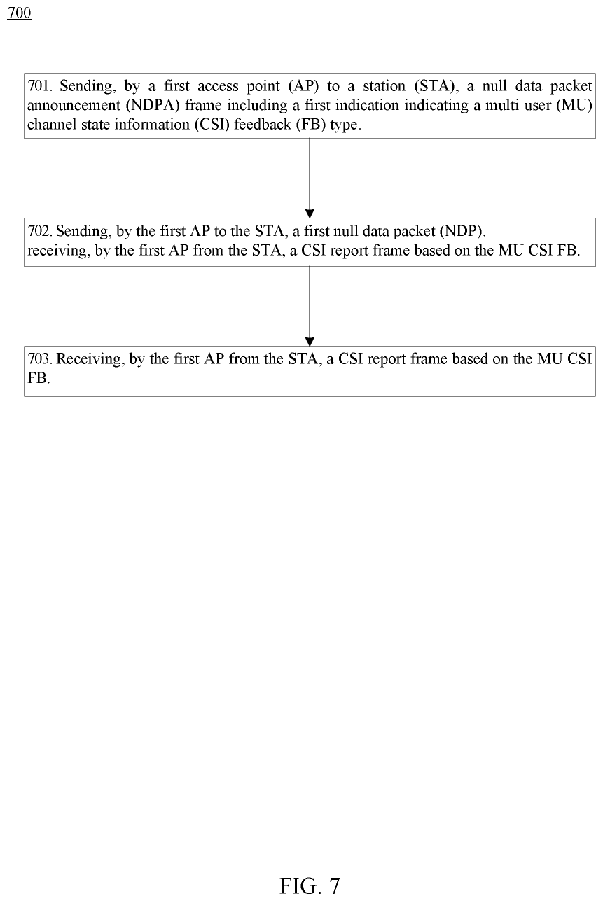

FIG. 7 illustrates a non-TB sounding procedure, by an AP, according to an aspect. The procedure 700 may be performed by an AP, e.g., AP 401 or AP 601. The procedure 700 may include, sending 701, by a first access point (AP) to a station (STA), a null data packet announcement (NDPA) frame. The NDPA frame may include a first indication indicating a multi-user (MU) channel state information (CSI) feedback (FB) type.

The procedure 700 may further include sending 702, by the first AP to the STA, a first null data packet (NDP). The procedure 700 may further include receiving 703, by the first AP from the STA, a CSI report frame based on the MU CSI FB.

In some embodiments, the first indication may be indicated via one or more subfields in a STA info field of the NDPA frame. In some embodiments, the one or more subfields may include a Feedback Type And Ng subfield and a Codebook Size subfield. In some embodiments, the first indication may be indicated via a bit combination of the one or more subfields. In some embodiments, the bit combination may be based on setting bit 25 (B25) and bit 26 (B26) of the Feedback Type And Ng subfield respectively to 0 and 1. In some embodiments, the bit combination may be based on setting B25 and the B26 of the Feedback Type And Ng subfield and bit 28 (B28) of the Codebook Size subfield respectively to 0, 1, and 1. In some embodiments, the bit combination may be based on setting the B25, the B26 and the B28 respectively to 0, 0, and 1. In some embodiments, the bit combination may be based on setting the B25, the B26 and the B28 respectively to 1, 0, and 0. In some embodiments, the bit combination may be based on setting the B25, the B26 and the B28 respectively to 1, 0, and 1.

In some embodiments, the first NDP may be sent a short interframe space (SIFS) time unit after sending the NDPA frame.

In some embodiments, the NDPA frame may include a second indication indicating a joint sounding among the first AP and a second AP. The second indication may further indicate that a second NDP from the second AP is to be transmitted to the STA concurrently with the first NDP. In some embodiments, the second indication is indicated via at least one bit in the NDPA frame. In some embodiments, the second indication is indicated in common info field of the NDPA frame.

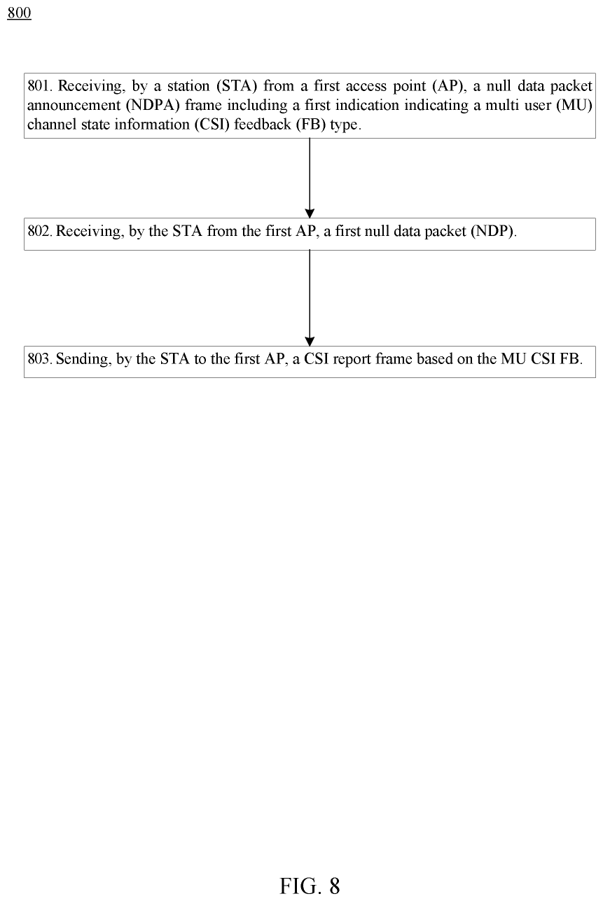

FIG. 8 illustrates a non-TB sounding procedure, by a STA, according to an aspect. The sounding procedure 800 may be performed by a STA, e.g., STA 411 or 611. The procedure 800 may include receiving 801, by a station (STA) from a first access point (AP), a null data packet announcement (NDPA) frame including a first indication indicating a multi-user (MU) channel state information (CSI) feedback (FB) type. The procedure 800 may further include receiving 802, by the STA from the first AP, a first null data packet (NDP). The procedure 800 may further include sending 803, by the STA to the first AP, a CSI report frame based on the MU CSI FB.

In some embodiments, the first indication may be indicated via one or more subfields in a STA info field of the NDPA frame. In some embodiments, the one or more subfields may include a Feedback Type And Ng subfield and a Codebook Size subfield. In some embodiments, the first indication may be indicated via a bit combination of the one or more subfields. In some embodiments, the bit combination may be based on setting bit 25 (B25) and B26 of the Feedback Type And Ng subfield respectively to 0 and 1. In some embodiments, the bit combination may be based on setting B25 and the B26 of the Feedback Type And Ng subfield and B28 of the Codebook Size subfield respectively to 0, 1, and 1. In some embodiments, the bit combination may be based on setting the B25, the B26 and the B28 respectively to 0, 0, and 1. In some embodiments, the bit combination may be based on setting the B25, the B26 and the B28 respectively to 1, 0, and 0. In some embodiments, the bit combination may be based on setting the B25, the B26 and the B28 respectively to 1, 0, and 1. In some embodiments, the first NDP is received short interframe space (SIFS) time unit after receiving the NDPA frame.

In some embodiments, the NDPA frame may include a second indication indicating a joint sounding among the first AP and a second AP. The second indication may further indicate that a second NDP from the second AP is to be transmitted to the STA concurrently with the first NDP. In some embodiments, the second indication may be indicated via at least one bit in the NDPA frame. In some embodiments, the second indication is indicated in common info field of the NDPA frame.

In some embodiments, procedure 800 may further include receiving, by the STA from the second AP, the second NDP concurrently with the first NDP. In some embodiments, procedure 800 may further include sending, by the STA from to the second AP, the CSI report frame.

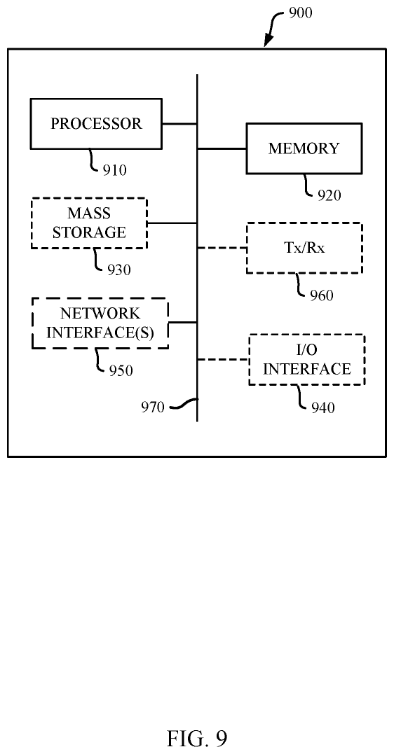

FIG. 9 illustrates an apparatus 900 that may perform any or all of operations of the methods and features explicitly or implicitly described herein, according to one or more aspects of the disclosure. For example, a computer equipped with network function may be configured as the apparatus 900. In some aspects, the apparatus 900 can be an electronic device (ED). In some aspect, apparatus 900 can a device that connects to the network infrastructure over a radio interface, such as a mobile phone, smart phone or other such device that may be classified as user equipment (UE). In some aspects, the apparatus 900 may be a Machine Type Communications (MTC) device (also referred to as a machine-to-machine (m2m) device), or another such device that may be categorized as a UE despite not providing a direct service to a user. In some aspects, apparatus 900 may be used to implement one or more aspects described herein. For example, the apparatus 900 may be configured to perform operations performed by an AP (e.g., AP1 401, 601 or 602) or a STA (e.g., STA1 411 or 511) described herein.

As shown, the apparatus 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. According to certain aspects, any or all of the depicted elements may be utilized, or only a subset of the elements. Further, apparatus 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random-access memory (SRAM), dynamic random-access memory (DRAM), synchronous DRAM (SDRAM), read-only memory (ROM), any combination of such, or the like. The mass storage element 930 may include any type of non-transitory storage device, such as a solid-state drive, hard disk drive, a magnetic disk drive, an optical disk drive, USB drive, or any computer program product configured to store data and machine executable program code. According to certain aspects, the memory 920 or mass storage 930 may have recorded thereon statements and instructions executable by the processor 910 for performing any of the aforementioned method operations described above.

According to embodiments, the present disclosure may be implemented as a chip, where the chip includes a processor and a data interface, and the processor reads, by using the data interface, an instruction stored in a memory, to perform one or more of the methods the described herein.

For example, a chip can be configured as a system on a chip or system-on-chip (SOC) which is readily understood to be an integrated circuit or package that integrates most or all components of a computer or other electronic system. These components can include a central processing unit (CPU), memory interfaces, on-board memory, on-chip input/output devices, input/output interfaces and secondary storage interfaces, potentially alongside other components such as radio modems and a graphics processing unit (GPU) on a single substrate or microchip. A SOC may contain one or more of digital, analog, mixed signal radio frequency signal processing functions, as would be readily understood.

As another example, a chip can be configured as a wireless chipset, which as is readily understood, is a piece of internal hardware designed to allow a device to communicate with another wireless-enabled device. This type of chipset can be found inside computers as well as a number of other wireless products, which can include an access point (AP), mobile station (STA), user equipment (UE) or other wireless device as would be readily understood. This hardware part can be called a chipset because parts of its type are usually made of two or more connected chips, though some chipsets only have one chip.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include a number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method of non-TB sounding, the method comprising:
sending, by a first access point (AP) to a station (STA), a null data packet announcement (NDPA) frame including a first indication indicating a multi-user (MU) channel state information (CSI) feedback (FB) type;
sending, by the first AP to the STA, a first null data packet (NDP); and
receiving, by the first AP from the STA, a CSI report frame based on the MU CSI FB.

2. The method of claim 1, wherein the first indication is indicated via one or more subfields in a STA info field of the NDPA frame.

3. The method of claim 2, wherein the one or more subfields include a Feedback Type And Ng subfield and a Codebook Size subfield.

4. The method of claim 3, wherein the first indication is indicated via a bit combination of the one or more subfields.

5. The method of claim 4, wherein the bit combination comprises any one of:
setting bit 25 (B25) and bit 26 (B26) of the Feedback Type And Ng subfield respectively to: 0, 1;
setting B25 and the B26 of the Feedback Type And Ng subfield and bit 28 (B28) of the Codebook Size subfield respectively to: 0, 1, 1;
setting the B25, the B26 and the B28 respectively to: 0, 0, 1;
setting the B25, the B26 and the B28 respectively to: 1, 0, 0; and
setting the B25, the B26 and the B28 respectively to: 1, 0, 1.

6. The method of claim 1, wherein the first NDP is a sent short interframe space (SIFS) time unit after sending the NDPA frame.

7. The method of claim 1, wherein the NDPA frame includes a second indication indicating a joint sounding among the first AP and a second AP, wherein the joint sounding indicates that a second NDP from the second AP is to be transmitted to the STA concurrently with the first NDP.

8. The method of claim 7, wherein the second indication is indicated via at least one bit in the NDPA frame.

9. The method of claim 7, wherein the second indication is indicated in a common info field of the NDPA frame.

10. A method of non-TB sounding, the method comprising:
receiving, by a station (STA) from a first access point (AP), a null data packet announcement (NDPA) frame including a first indication indicating a multi-user (MU) channel state information (CSI) feedback (FB) type;
receiving, by the STA from the first AP, a first null data packet (NDP); and
sending, by the STA to the first AP, a CSI report frame based on the MU CSI FB.

11. The method of claim 10, wherein the first indication is indicated via one or more subfields in a STA info field of the NDPA frame.

12. The method of claim 11, wherein the one or more subfields include a Feedback Type And Ng subfield and a Codebook Size subfield.

13. The method of claim 12, wherein the first indication is indicated via a bit combination of the one or more subfields.

14. The method of claim 13, wherein the bit combination comprises on one of:
setting bit 25 (B25) and bit 26 (B26) of the Feedback Type And Ng subfield respectively to: 0, 1;
setting B25 and the B26 of the Feedback Type And Ng subfield and bit 28 (B28) of the Codebook Size subfield respectively to: 0, 1, 1;
setting the B25, the B26 and the B28 respectively to: 0, 0, 1;
setting the B25, the B26 and the B28 respectively to: 1, 0, 0; and
setting the B25, the B26 and the B28 respectively to: 1, 0, 1.

15. The method of claim 10, wherein the first NDP is received a short interframe space (SIFS) time unit after receiving the NDPA frame.

16. The method of claim 10, wherein the NDPA frame includes a second indication indicating a joint sounding among the first AP a second AP, wherein the joint sounding indicates that a second NDP from the second AP is to be transmitted to the STA concurrently with the first NDP.

17. The method of claim 16, wherein the second indication is indicated via at least one bit in the NDPA frame.

18. The method of claim 17, wherein the second indication is indicated in a common info field of the NDPA frame.

19. The method of claim 17, further comprising:
receiving, by the STA from the second AP, the second NDP concurrently with the first NDP; and
sending, by the STA from to the second AP, the CSI report frame.

20. An apparatus comprising:
at least one processor; and
at least one non-transitory machine-readable medium storing executable instructions which when executed by the at least one processor configure the apparatus to:
send to a station (STA), a null data packet announcement (NDPA) frame including a first indication indicating a multi-user (MU) channel state information (CSI) feedback (FB) type;
send to the STA, a first null data packet (NDP); and
receive from the STA, a CSI report frame based on the MU CSI FB.
